(19) United States
(12) Patent Application Publication
(10) Pub. No.: US 2025/0320429 A1
(43) Pub. Date: Oct. 16, 2025

(54) SOLID COMPOSITION, LIQUID AND VISCOUS CLEANING FORMULATION OBTAINED BY DISSOLVING THE SOLID COMPOSITION, METHODS FOR PREPARING, DISTRIBUTING AND USE OF A LIQUID AND VISCOUS CLEANING FORMULATION

(71) Applicant: Oxiteno S.A. Indústria e Comércio, São Paulo (BR)

(72) Inventors: Cristiane Aparecida Furtado CANTO, São Paulo, SP (BR); Cléber Faller BAUER, São Paulo, SP (BR); Vicente Gomes OLIVEIRA, Santo André, SP (BR); André Oliva DE PALMA, Mauá São Paulo (BR); Claudivania Pereira CELESTINO, Mauá São Paulo (BR)

(73) Assignee: Oxiteno S.A. Indústria e Comércio, São Paulo (BR)

(21) Appl. No.: 18/560,697

(22) PCT Filed: May 11, 2022
(86) PCT No.: PCT/BR2022/050160

§ 371 Date: Nov. 14, 2023

(30) Foreign Application Priority Data
May 14, 2021 (BR) BR1020210093838

(51) Int. Cl. C11D 3/20; C11D 3/37; C11D 3/43

(52) U.S. Cl. CPC C11D 3/2093; C11D 3/3707; C11D 3/43

(57) ABSTRACT

The disclosure refers to a solid composition that provides increased viscosity after being dissolved, as well as a liquid and viscous formulation for cleaning and use thereof in cleaning and personal care products, as well as methods for preparing and for distribution of said liquid and viscous formulation.

### FIELD OF APPLICATION

This disclosure relates to a solid composition for cleaning products that can be dissolved by the final consumer before or at the time of use.

Additionally, the present disclosure also relates to a liquid and viscous cleaning formulation and the use thereof.

Furthermore, the present disclosure relates to methods for preparing and dispensing said liquid and viscous cleaning formulation.

### BACKGROUND OF THE INVENTION

In the industry of cleaning or personal care and beauty products, rheological modifiers are commonly used in order to modify the viscosity of the product. One of the purposes for the use of said modifiers is the commercialization of “concentrated” products on the market, which have a higher yield and can also be diluted or dissolved without damaging their action. For the specific case of cleaning products, there is no damage to the cleaning action.

In addition, because they are in a concentrated form, these products need smaller packaging, and are also used in the form of a refill, thus providing benefits to the environment by reducing the solid waste eventually generated.

Conventionally, compositions comprising acrylic polymers, vinyl copolymers and natural polymers are used as rheological modifiers for fabric and surface cleaners, such as liquid laundry detergents, as well as in dishwashers, surface cleaners, bleaches, and sanitary disinfectants.

However, such concentrated products still use water in their composition, increasing the volume of the commercialized product and directly impacting the amount of waste from the production process as a whole, since there is a need to use larger amounts of material for storage and shipping of the commercialized product.

It is known that acrylic polymers and copolymers do not provide good results when used with concentrated products because after dilution they generate a formulation in the form of a gel that is not optimal for use, and they do not promote a formulation viscosity increase when diluted.

PCT/US2004/027317 discloses a personal cleansing composition containing ethoxylated sorbitol ester. However, the ethyoxylated sorbitol ester is not responsible for thickening the formulation, but rather another ingredient added for this purpose, the hydrophobically modified anionic acrylic copolymer. The ethoxylated sorbitan ester is used in this formulation as a non-ionic surfactant, specifically as an emulsifier, comprising a degree of ethoxylation between 20-80 moles of ethylene oxide (EO). Under these conditions, in which the sorbitan ester has one or two carbon chains of fatty acids, as well as moderate to low degrees of ethoxylation, ethoxylated sorbitol ester provides amphiphilic molecules with a surface-active character, with HLB (hydrophilic-lipophilic balance) suitable for the emulsifier function, comprised in the range of 8-18. These molecules are widely known in the literature by the trade name “Tween”. However, when ethoxylated sorbitan esters with two (di), three (tri), four (tetra-), five (penta-), or six (hexa-) carbon chains from fatty acids are combined at high degrees of ethoxylation, as in the given invention, between 300 and 500 moles of EO, the molecule no longer presents a surfactant character and does not have the function of an emulsifying non-ionic surfactant, like the ethoxylated sorbitan esters of the “Tween” type. These high molecular weight esters acquire thickening functions in the formulation, due to the formation of transient networks formed between the fatty chains of the high molecular weight molecules and the internal part of the micelles of the surfactants in the formulation, keeping the ethoxylated portions in water, through the mechanism of associative thickening.

Compositions for substantially water-free products (waterless) are a possible alternative for minimizing the volume of solid waste eventually generated and discarded in the environment.

Thus, it is necessary to develop compositions for cleaning products, which can be made available in solid form (waterless products), so that they can be dissolved by the final consumer and have the same properties as the products originally prepared and marketed in liquid or concentrated liquid form.

In this regard, PCT/US2004/027317 shows a mild cleaning composition which includes an anionic surfactant, a hydrophobically modified crosslinked anionic acrylic copolymer and a non-ionic surfactant which offers good foaming properties. However, the document refers to cosmetic uses only, or in conjunction with cleaning instruments, such as wipes, beanbags, sponges, cloths and the like. In addition, the product contains an acrylic copolymer, which does not increase the viscosity of the formulation after dilution, as explained above.

PCT/US1998/008931, on the other hand, shows a cosmetic composition with desired viscosity properties that, counter-intuitively, increase with increasing temperature. The composition of this document may be used as a liquid, spray, semi-solid gel, cream, ointment, lotion, stick, roll-on formulation, mousse, pad-applied formulation and film-forming formulation. However, in addition to using a poloxamer and poly(acrylic acid) component, which are known not to generate good viscosity results in formulations that are presented in concentrated form, it is necessary to heat the composition to obtain the desired viscosity increase.

PCT/US2017/066252 shows a fabric care composition that includes a fabric softening agent comprising polyquartenium-7, a thickener that includes at least one polyoxyethylene sorbitol tetrastearate thickener, an acrylic copolymer, and a co-solvent that includes alcohol ethoxylates. As stated earlier, the use of acrylic polymers commonly does not result in good viscosity in viscous and liquid formulations.

PCT/EP2018/084580 describes more effective and less expensive fragranced laundry and cosmetics formulations comprising non-ionic surfactants such as sorbitan polyethylene esters, sorbitol esters, fatty alcohols and glycerol esters. Despite meeting the purpose of providing more effective and less expensive fragrances for clothes and cosmetics washing formulations, the composition gives preference to the use of non-ionic surfactants.

The document PCT/EP2018/067944 describes packages containing compositions for dishwashing or laundry treatment, method of producing such packages and their use in dishwashing and textile washing or textile treatment comprising a film-forming material and an anionic surfactant, as well as a method of treating a fabric item. The compositions are presented as a powder, particulate, tablet or granular and non-soluble form. Also, the publication reveals a powdered laundry detergent wrapped in a water-soluble plastic presented in a single-dose format for use by the consumer directly in the washing machine, which represents a significant gain in convenience in dosing the product at the time of use.

PCT/KR2015/009213 describes a washing detergent formulation in thin film format, whose compressed ingredients are non-ionic surfactants (polyoxyethylene alkyl ether, coconut diethanolamide, fatty acid alkanolamine, amine oxide, polyglucoside alkyl, methyl polyethylene alkyl ether and sugar ether), anionic surfactants (alpha sulfa fatty acid methyl ester salt, alpha olefin sulfonate and sodium lauryl sulfate), water-soluble film-forming polymer (polyvinyl alcohol), plasticizer (trimethylol propane, ethylene glycol, dibutyl phthalate and citric acid), filler (sodium carbonate, sodium bicarbonate and sodium sulfate) and other additives.

PCT/US2018/015364 describes solid soluble effervescent structures having fibers formed from a composition comprising surfactant and water-soluble polymeric structuring agent, whose compressed ingredients are anionic surfactants (ammonium lauryl sulfate, ammonium laureth sulfate, triethylamine lauryl sulfate, triethanolamine lauryl sulfate, monoethanolamine lauryl sulfate, diethanolamine lauryl sulfate, diethanolamine laureth sulfate, sodium lauric sulfate monoglyceride, sodium lauryl sulfate, sodium laureth sulfate, potassium lauryl sulfate, sodium lauryl sarcosinate, sodium lauroyl sarcosinate, lauryl sarcosine, cocoyl sarcosine, ammonium cocoyl sulfate, ammonium lauroyl sulfate, sodium cocoyl sulfate, sodium lauroyl sulfate, potassium cocoyl sulfate, lauryl sulfate triethanolamine, triethan lauryl olamine sulfate, monoethanolamine cocoyl sulfate, sodium tridecyl benzene sulfonate, sodium dodecyl benzene sulfonate, sodium cocoyl isethionate and combinations thereof), water-soluble film-forming polymer (polyvinyl alcohol), polymeric builders (polyalkylene oxides, polyvinyl alcohols, polyacrylates, copolymers of acrylic acid and methacrylic acid, polyvinylpyrrolidones, polyvinyl methyl ether, polyvinylformamide, polyacrylamide, starch and starch derivatives, pullulan, gelatin, hydroxypropylmethylcelluloses, methylcelluloses, carboxymethylcelluloses, salts and combinations thereof).

PCT/EP2020/055911 describes a shampoo or conditioner formulation in different formats, whose compressed ingredients are anionic surfactants (sodium lauryl ether sulfate, amphoteric surfactant (Cocoamidopropyl betaine)), thickening agents (Guar gum, polyquartenium-10) and other additives (dimethicone, polyethylene glycol, fragrance, preservatives and pH adjusting agents). The final product is presented in a solid format and dissolved in a “pump” format package, which delivers the product directly to the consumer in the foam format.

Thus, there are no reports or disclosures in the state of the art that anticipate a solid composition for cleaning products that can be dissolved by the final consumer before or at the time of use and that still has the same desired foaming, viscosity and detergency properties of the products originally marketed in liquid or concentrated liquid form.

For this reason, there is a need to produce a cleaning composition, but reducing costs with shipping, packaging and storage, in addition to being easy to handle and eliminating the need for energy expenditure to achieve the optimal properties for use.

### SUMMARY OF THE INVENTION

The first purpose of the disclosure is to provide a “waterless” cleaning solid composition with reduced costs both in terms of the raw materials used, as well as packaging, storage and shipping.

The second purpose of the disclosure is to provide a viscous and liquid cleaning formulation obtained from the aforementioned solid composition, which can be dissolved by the consumer for immediate use or when desired later.

The third purpose of the disclosure is to provide a method for the preparation of liquid and viscous cleaning formulation in the domestic and/or industrial scope.

The fourth purpose of the disclosure is to provide a method for delivering a viscous and liquid and viscous cleaning formulation to surfaces.

The fifth purpose of the disclosure addresses the use of the liquid and viscous cleaning formulation in cleaning products.

The purposes and other advantages of the disclosed embodiments will be better evidenced from the following detailed description and the images attached.

### BRIEF DESCRIPTION OF DRAWINGS

FIG. 1 represents the results of comparative detergent tests for the liquid and viscous cleaning formulation applied to different types of stains and fabrics.

FIG. 2 represents the results of the comparative foaming tests for the different detergents through the analysis of the final number of bubbles per mm².

FIG. 3 represents the results of the comparative foaming tests for the different detergents through the analysis of the foam height produced (mm).

### DETAILED DESCRIPTION OF THE INVENTION

The disclosed embodiments relate to a water-free cleaning composition.

By aiming to get to compositions that generate good viscosity results without loss of detergency and/or cleaning, the disclosure aims at the development of a solid state composition. The disclosure also provides processability gains. Additionally, the surfactants present in the composition contribute to the detergency and cleaning process.

More precisely, the solid composition comprises:
a) one or more (di-, tri-, tetra-, penta-, or hexa-) ethoxylated sorbitol esters;
b) one or more polyethylene glycol esters;
c) one or more non-ionic surfactants;
d) one or more anionic surfactants; and
e) one or more amphoteric surfactants.

### A) Ethoxylated Sorbitol Esters

For the disclosed embodiments, ethoxylated sorbitol esters are produced from sorbitol, which is ethoxylated with EO (ethylene oxide) until an ethoxylated sorbitol is obtained. Preferably, the ethoxylated sorbitol produced comprises from about 200 to about 500 moles of EO for each mole of sorbitol. This is due to the fact that the solubility in water is directly proportional to the number of moles of EO.

After ethoxylation, the ethoxylated sorbitol undergoes an esterification step with linear saturated fatty acids, pure or in the form of mixtures, being at least one of: myristic acid, oleic acid, palmitic acid or, preferably, stearic acid, or a mixture thereof. As a result, a composition comprising a mixture of ethoxylated di-, tri-, tetra-, penta-, and hexa-esters of sorbitol is obtained.

In accordance with the disclosed embodiments, the ethoxylated sorbitol esters are used in a content of from about 6% by weight to about 35% by weight based on the total weight of the composition. Particularly, ethoxylated (di-, tri-, tetra-, penta-, or hexa-) esters of sorbitol are used in a content of from about 20% by weight to about 30% by weight based on the total weight of the composition. More precisely, the one or more (di-, tri-, tetra-, penta-, or hexa-) ethoxylated sorbitol esters is ethoxylated (tri-, tetra-) sorbitol stearate with about 300 to about 500 moles of EO per mole of sorbitol. Even more preferably the composition comprises about 20% by weight, based on the total weight of the composition, of one or more (tri-, tetra-) sorbitol stearate ethoxylated with about 300 to about 500 moles of EO per mole of sorbitol.

### B) Polyethylene Glycol Esters

In the disclosed embodiments, one or more polyethylene glycol esters are compounds produced from the esterification of polyethylene glycol with one or more acids, preferably stearic acid. Even more preferably, one or more polyethylene glycol esters is PEG-150 distearate.

In one embodiment, the one or more polyethylene glycol esters comprise from about 2% by weight to about 10% by weight based on the total weight of the composition. Preferably, the composition comprises from about 5% by weight to about 10% by weight, based on the total weight of the composition, of one or more polyethylene glycol esters. Even more preferably the composition comprises about 5% by weight of PEG-150 distearate based on the total weight of the composition.

### C) Non-Ionic Surfactants

In the disclosed embodiments, non-ionic surfactants refer to compounds that do not dissociate into ions when placed in an aqueous solution, which results in greater compatibility with other surfactants. In addition, this class of surfactants has excellent emulsifying and thickening features.

Among the possible surfactants of this class are ethoxylated fatty alcohols, fatty acid amides, their counterparts and combinations thereof. Also, ethoxylated fatty alcohols are compounds produced from the ethoxylation of a fatty alcohol, preferably linear saturated fatty alcohols, pure or in the form of mixtures, with at least one of: myristic alcohol, oleic alcohol, palmitic alcohol, stearic alcohol, or preferably, lauric alcohol, or a combination thereof. Even more preferably, the ethoxylated fatty alcohol is laureth-23.

In the disclosed embodiments, the non-ionic surfactants comprise from about 5% by weight to about 35% by weight based on the total weight of the composition. Preferably, the non-ionic surfactants comprise from about 20% by weight to about 30% by weight based on the total weight of the composition. Even more preferably, the laureth-23 makes up about 20% by weight based on the total weight of the composition.

### D) Anionic Surfactant

In the disclosed embodiments, anionic surfactants refer to compounds with a high degree of foaming and detergency. Among the anionic surfactants, there are the sulfated fatty alcohols, being produced from the sulfation of fatty alcohols such as sulfated fatty alcohols, sulfated ethoxylated fatty alcohols, alkyl sulfonates or mixtures thereof. Then, neutralization is made with a sodium base or salt, preferably sodium carbonate and sodium hydroxide.

In a preferred embodiment, the sulfated fatty alcohol is sodium lauryl sulfate, sodium lauryl ether sulfate, linear alkylbenzene sulfonate or a mixture thereof.

In one embodiment, the anionic surfactants comprise from about 20% by weight to about 70% by weight based on the total weight of the composition. Preferably, the composition comprises from about 50% by weight to about 70% by weight of anionic surfactants based on the total weight of the composition. More preferably, the composition comprises about 50% by weight, based on the total weight of the composition, of anionic surfactants and even more preferably the composition comprises a mixture of about 50% by weight of sodium lauryl sulfate, about 3.3% by weight of sodium lauryl ether sulfate and about 0.3% by weight of linear alkylbenzene sulfonate based on the total weight of the composition.

### E) Amphoteric Surfactants

In the disclosed embodiments, amphoteric surfactants refer to surfactant substances capable of interacting with a liquid and reducing irritability when in contact with the skin. In addition, this class of surfactant, as it contains acidic or basic features, can be used at different pHs. Among amphoteric surfactants, betaines, sultains or oxide amines, or mixtures thereof are preferable. Even more preferably, the present composition comprises cocoamidopropyl betaine.

In one embodiment, the amphoteric surfactant is from about 0% by weight to about 5% by weight based on the total weight of the composition. That is, the composition can be exempt from this component. However, in a preferred embodiment, the composition comprises about 0% to about 2% of the amphoteric surfactant based on the total weight of the composition. Even more preferably, the composition comprises about 0.2% by weight cocoamidopropyl betaine based on the total weight of the composition.

### F) Additional Components

The composition may further comprise from about 1% to about 25% actives or adjuvants or a combination thereof based on the total weight of the composition.

In the disclosed embodiments, the actives can be silicas, enzymes, preservatives, salts, solvents, emollients, co-surfactants, stabilizers, spreaders, emollients or the like or a combination thereof.

Additionally, adjuvants can be components intended to improve their organoleptic features such as, flavoring fragrances, pigments, dyes, optical brighteners, or the like or a combination thereof.

As for the form of presentation, the present solid composition can be found in the form of powders, flakes, granules, pellets, tablet, pills, needles, lozenge, disk, briquette, bar, block or the like or mixtures thereof.

Advantageously, the composition of the disclosure is able to minimize the size of the container and/or package necessary for its packaging, thus reducing the expense of packaging materials, which are commonly discarded. Therefore, the solid residue related to the present composition is also reduced as well as the cost for shipping, storage and storage, since there is no need to shipping water.

Thus, the present disclosure provides economic advantages, in view of the reduction of the volume to be transported, and environmental advantages, due to the minimization of waste generated in the process. Thus, a unique, stable, processable composition of commercial interest is provided, presenting outstanding thickening properties, and allowing the thickening of systems that show viscosity gain when dissolved or diluted (“concentration-triggered thickening mechanism”), in which the use of conventional rheological modifiers works poorly.

Additionally, the present composition also allows the reduction of the surfactant content added to its formulation. Thus, the end consumer can determine the desired concentration of actives from the dissolution. In other words, if a low-concentrated formulation is required during use, the end consumer can increase the volume of diluent without loss of product efficiency. In addition, the composition as described promotes a more effective thickening in formulations with rheological modifiers similar to those used in this invention, requiring a lower dosage in the product.

For purposes of use, the solid composition is soluble and becomes a viscous liquid. In addition, the composition promotes liquid and viscous formulations for cleaning and personal care when dissolved, whose formulations comprise:
a) one or more (di-, tri-, tetra-, penta-, or hexa-) ethoxylated sorbitol esters;
b) one or more polyethylene glycol esters;
c) one or more non-ionic surfactants;
d) one or more anionic surfactants;
e) one or more amphoteric surfactants; and
at least one solvent.

Components a) to e) are as detailed above. Additionally, the formulation may contain additional components f) such as actives and adjuvants as also detailed in the preceding paragraphs.

Among the possible solvents, it is possible to list water, a glycol, an alcohol, another polar solvent, combinations thereof or any other solvent. Thus, the cleaning composition has a viscosity of between about 100 mPa·s and about 2000 mPa·s at 25° C., preferably between about 250 mPa·s and about 500 mPa·s and pH greater than or equal to about 4.0, preferably between about 7.0 and about 9.0, and even more preferably about 8.5.

Positively, the liquid and viscous cleaning formulation of the present disclosure has foaming, viscosity and detergency properties substantially similar to a cleaning composition originally prepared in liquid form which will be demonstrated in the detergency and foaming tests below.

Thus, the liquid and viscous cleaning formulation can be used on soft or hard surfaces. For example, the formulation can be used in cleaning products for clothing, fabrics or non-wovens, cleaning products for dishes and household items, cleaning products for floors or coverings, tile or the like.

The present disclosure further relates to a method for preparing a viscous and liquid formulation. More precisely, the method comprises substantially dissolving completely the solid composition comprising:
a) one or more (di-, tri-, tetra-, penta-, or hexa-) ethoxylated sorbitol esters;
b) one or more polyethylene glycol esters;
c) one or more non-ionic surfactants;
d) one or more anionic surfactants; and
e) one or more amphoteric surfactants, in at least one solvent forming a viscous and liquid formulation.

In the present disclosure, the solvent may be selected as described above.

In the present disclosure, components a) to e) are as detailed above. Additionally, the predecessor composition may contain the additional components f) as actives and adjuvants as also detailed in the preceding paragraphs.

Advantageously, the dissolution is carried out at room temperature, i.e. without heating the composition. Consequently, the powders, flakes, granules, pellets, tablets, pills, needles, lozenges, disks, briquettes, bars, blocks or the like do not need to go through a pre-dilution step to be used, facilitating use by the final consumer.

Another advantage of the disclosed embodiments is the fact that the formulation obtained provides foaming, viscosity and detergency properties substantially similar to a cleaning composition originally prepared in liquid form.

In addition, the innovative liquid and viscous formulation differs from other existing cleansing and personal care formulations in that it is obtained by dissolving a water-free, predecessor solid composition.

The present disclosure also relates to a method for dispensing a viscous and liquid formulation comprising:
(i) preparing a viscous and liquid cleaning formulation from substantially complete dissolution of the solid composition comprising:
a) one or more (di-, tri-, tetra-, penta-, or hexa-) ethoxylated sorbitol esters;
b) one or more polyethylene glycol esters;
c) one or more non-ionic surfactants;
d) one or more anionic surfactants; and
e) one or more amphoteric surfactants;
in at least one solvent; and
(ii) contacting the obtained formulation with a surface.

In the present disclosure, components a) to e) and the solvent are as detailed above. Additionally, the predecessor composition may contain the additional components f) as actives and adjuvants as also detailed in the preceding paragraphs.

In one embodiment, soft or hard surfaces are the surfaces on which the formulation can be used, in addition to the others not listed herein. Preferably, the formulation is contacted with clothing, fabrics or non-wovens, cleaning products for dishes and household items, floors or coverings, tile or the like.

The present disclosure also relates to the use of a viscous and liquid cleaning formulation obtained from the solid composition of the present invention in cleaning products for soft or hard surfaces.

More precisely, the use of the liquid and viscous cleaning formulation of the present invention is in cleaning products for clothes, fabrics or non-wovens, cleaning products for dishes and household utensils, cleaning products for floors or coverings, tile or the like.

The following table will start from non-exhaustive examples of a particular embodiment of the liquid and viscous cleaning formulation produced from the solid composition. As evidently shown below, the invention is not and should not be limited to such an embodiment.

### EXAMPLES

TABLE 1
Compositions and formulations to be evaluated

| | Diluted | Diluted | Diluted | Concentrated |
|---|---|---|---|---|
| | Laundry | Laundry | Laundry | Market Laundry |
| | Detergent | Detergent | Detergent | detergent 2 to |
| Examples | 1 | 2 | 3 | be Dissolved |
| Concentrated | 16.67% | 16.67% | 10.00% | 90.65% |
| Detergent | | | | |
| Composition | | | | |
| Silica | | 0.80% | | 6.00% |
| Enzymes | | | | 0.30% |
| Fragrance | | | | 0.80% |
| Dye | | | | 0.05% |
| Optical | | | | 0.20% |
| Brightener | | | | |
| Water | 83.33% | 82.53% | 90.00% | |

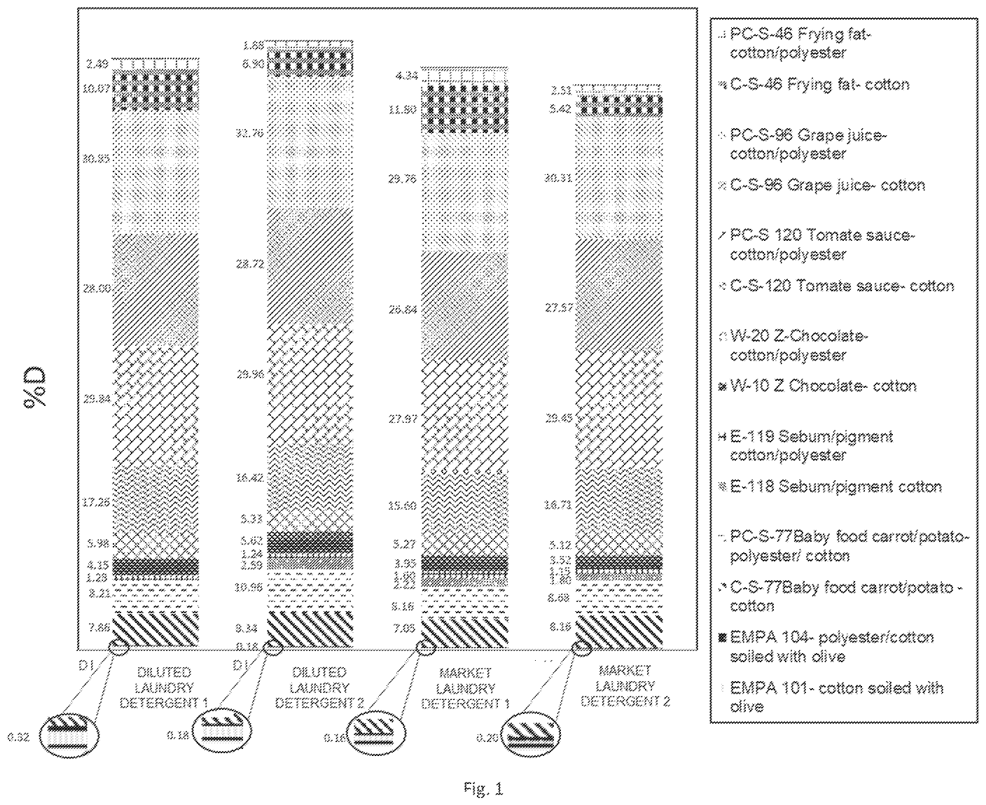

From the compositions and formulations indicated in Table 1, tests were carried out to demonstrate the detergency and foamability of the formulation as described below. It is noted that the Diluted Laundry Detergents 1 and 2 (columns 1 and 2 of Table 1 above) are shown in Figures Market Laundry Detergent 2 of FIGS. 1-3 corresponds to the 1-3. “Concentrated Market Laundry Detergent 2 to be Dissolved” of Table 1 (column 4) after dilution.

### Experimental Tests

### Detergency Test

Detergency, that is, the ability to remove dirt, was evaluated by washing fabrics with different cleaning formulations: the diluted laundry detergents of examples 1 and 2, a regular market laundry detergent 1 without enzymes, and a concentrated market 2 washing detergent with enzymes for pre-use dilution (see column 4 of Table 1, above). 10×10 cm cotton and cotton/polyester fabrics containing standard soiling (Center For Testmaterials BV, The Netherlands) were washed in 1-liter sinks on a tergotometer (TC 3500, Texcontrol, Brazil). Washing was made at a temperature of 25° C., with aqueous solutions of 2.5 g/L of the cleaning formulation, maintaining the ratio 1 kg [approx. 2 pounds] clothes/21 L of water, with soaking for 15 min, washing for 15 min, and 2 rinses of 2 min. After washing and drying the fabrics, the reflectance was obtained in a spectrophotometer with a Xenon lamp (Datacolor 400, Applied Color Systems Inc., United States). Detergency (% D) was given by the reflectance of the washed fabric (RL), by the reflectance of the soiled fabric (RS) and by the calibration with the white/unsoiled (R), calculated by: % D=(RL−RS)/(R−RS). FIG. 1 contains the results of the detergency tests. From the results, it was possible to prove that cleaning formulations containing the concentrated detergent composition presented high detergency.

In FIG. 1, the values for EMPA 101 could not be clearly represented. In FIG. 1, the values for EMPA-101-Cotton and EMPA-104-Polyester/Cotton are presented as below in Table 2.

TABLE 2

| | | EMPA |
|---|---|---|
| | EMPA | 104-Polyester/ |
| | 101-Cotton | Cotton |
| Diluted Laundry Detergent 1 | 0.95 | 0.32 |
| Diluted Laundry Detergent 2 | 0.73 | 0.18 |
| Market Laundry Detergent 1 | 0.48 | 0.16 |
| Market Laundry Detergent 2 | 0.26 | 0.20 |

### Foam Test

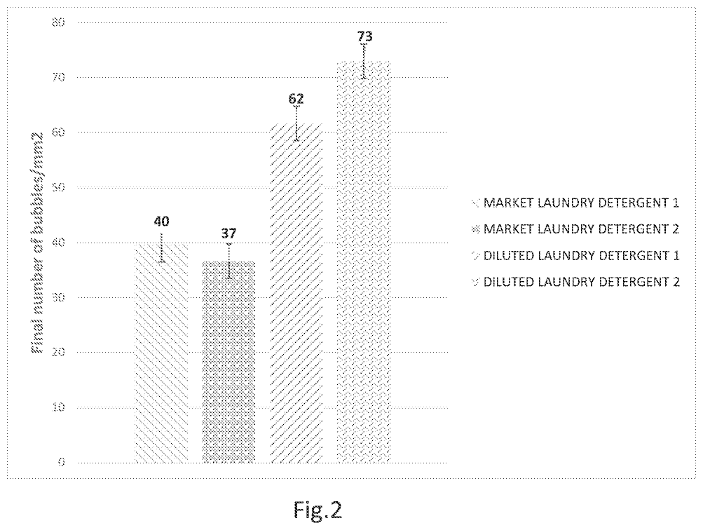

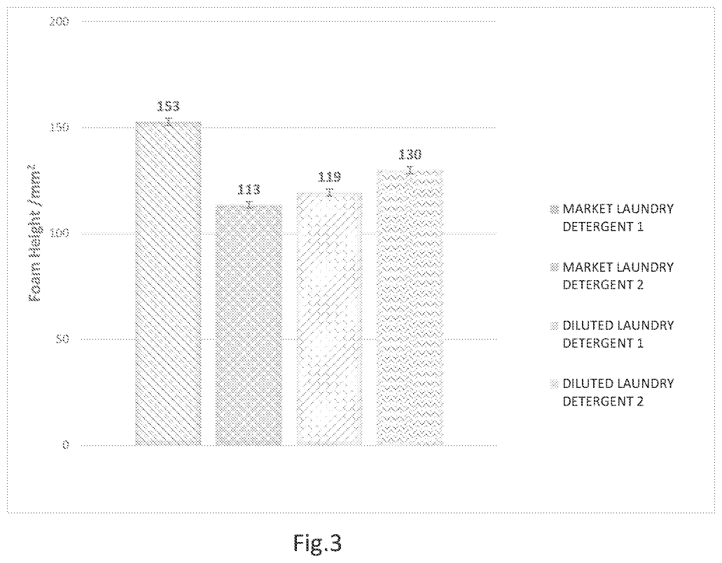

The foam generated by the cleaning formulations was evaluated by a dynamic foam analyzer (Krüss DFA 100, Krüss GmbH, Germany). The tests were carried out in triplicate, in which 50 mL of a 1% aqueous solution of the cleaning formulation was added to a jacketed cuvette at 25° C., and foam was generated by stirring the sample for 10 seconds using a rotor at 500 rpm. The foam height generated in the cuvette was monitored by a side camera and by a transmitted light detector over a total foam decay time of 5 min. The initial foam height and the final number of bubbles per area were recorded to prove the improved foam effect. The cleaning formulations compared were: the diluted laundry detergents of examples 1 and 2, a regular market 1 laundry detergent without enzymes, and a concentrated market 2 laundry detergent with enzymes for pre-use dilution. FIGS. 2 and 3 comprise the test results in relation to the number of final bubbles/mm² and foam height (mm), respectively. After analyzing the results, it was proved that the cleaning formulations containing the concentrated detergent composition resulted in a foaming with a creamier appearance, given the greater number of bubbles per area, and more abundant, given the high foam height evidenced.

From the analysis of the test results, it was possible to verify that the solid composition of the disclosed embodiments brought economic advantages in production, storage and shipping due to the absence of water, in addition to reducing the volume of the product to be commercialized.

As mentioned earlier, by reducing the volume of the product sold, packaging costs and expenses related to the product shipping and storage are also reduced.

It was then found that it was possible to produce a solid cleaning composition that, after dissolved, generated a liquid and viscous cleaning formulation that has the same foaming, viscosity and detergency properties of liquid products, concentrated or not, commonly marketed for industrial and/or domestic use.

Thus, it was possible to reduce costs with shipping and packaging, in addition to eliminating energy costs to reach an optimal point for the use of these compositions and/or formulations.

Numerous variations within the scope of protection of this application are permitted. Thus, it is emphasized the fact that the present invention is not limited to the particular configurations/embodiments described above.

1. A solid composition, comprising:
a) from about 6% by weight to about 35% by weight of one or more (di-, tri-, tetra-, penta-, or hexa-) ethoxylated sorbitol esters;
b) from about 2% by weight to about 10% by weight of one or more polyethylene glycol esters;
c) from about 5% by weight to about 35% by weight of one or more non-ionic surfactants;
d) from about 20% by weight to about 70% by weight of one or more anionic surfactant; and
e) from about 0% to about 5% of one or more amphoteric surfactants,
the percentages being calculated based on the total weight of the solid composition.

2. The solid composition according to claim 1, wherein the composition comprises from about 20% by weight to about 30% by weight of the one or more (di-, tri-, tetra-, penta-, or hexa-) ethoxylated sorbitol esters.

3. The solid composition according to claim 1, wherein the one or more (di-, tri-, tetra-, penta-, or hexa-) ethoxylated sorbitol esters is ethoxylated (tri-, tetra-) sorbitol stearate with about 300 to about 500 moles of EO per mole of sorbitol.

4. The solid composition according to claim 1, wherein the composition comprises from about 5% by weight to about 10% by weight of the one or more polyethylene glycol esters.

5. The solid composition according to claim 4, wherein the one or more polyethylene glycol esters is PEG-150 distearate.

6. The solid composition according to claim 1, wherein the composition comprises from about 20% by weight to about 35% by weight of the non-ionic surfactant.

7. The solid composition according to claim 6, wherein the one or more non-ionic surfactants are selected from the group consisting of ethoxylated fatty alcohols, fatty acid amides, and combinations thereof.

8. The solid composition according to claim 7, wherein the composition comprises laureth-23.

9. The solid composition according to claim 1, wherein the one or more anionic surfactants are selected from the group consisting of sulfated fatty alcohols, sulfated ethoxylated fatty alcohols, alkyl sulfonates or mixtures thereof.

10. The solid composition according to claim 9, wherein the composition comprises from about 50% to about 70% by weight of the anionic surfactant.

11. The solid composition according to claim 9, wherein the composition comprises about 50% sodium lauryl sulfate, about 3.3% sodium lauryl ether sulfate, and about 0.3% linear alkylbenzene sulfonate.

12. The solid composition according to claim 1, wherein the composition comprises from about 0% to about 2% of one or more amphoteric surfactants.

13. The solid composition according to claim 12, wherein the one or more amphoteric surfactants are selected from the group consisting of betaines, sultains or oxide amines, or mixtures thereof.

14. The solid composition according to claim 13, wherein the composition comprises about 0.2% cocoamidopropyl betaine.

15. The solid composition according to claim 1, wherein the composition further comprises
f) from about 1% to about 25% of actives or adjuvants,
wherein the actives or adjuvants are selected from the group consisting of silicas, preservative enzymes, salts, solvents, emollients, co-surfactants, stabilizers, spreaders, emollients, flavoring fragrances, pigments, dyes, optical brighteners, or a combination thereof.

16. The solid composition according to claim 1, wherein the composition is in the form of powders, flakes, granules, pellets, a tablet, pills, needles, a lozenge, a disk, a briquette, a bar, a block or mixtures thereof.

17. The solid composition according to claim 1, wherein the solid composition is dissolvable.

18. A liquid and viscous cleaning formulation, comprising:
a) from about 6% by weight to about 35% by weight of one or more (di-, tri-, tetra-, penta-, or hexa-) ethoxylated sorbitol esters;
b) from about 2% by weight to about 10% by weight of one or more polyethylene glycol esters;
c) from about 5% by weight to about 35% by weight of one or more non-ionic surfactants;
d) from about 20% by weight to about 70% by weight of one or more anionic surfactant;
e) from about 0% to about 5% of one or more amphoteric surfactants,
and at least one solvent.

19. The liquid and viscous cleaning formulation according to claim 18, wherein the at least one solvent is selected from the group consisting of water, a glycol, an alcohol, another polar solvent, combinations thereof, or any other liquid.

20. The liquid and viscous cleaning formulation according to claim 18, wherein the cleaning formulation has a viscosity between about 100 mPa·s and about 2000 mPa·s at 25° C.

21. The liquid and viscous cleaning formulation according to claim 18, wherein the cleaning formulation provides substantially similar foaming, viscosity and detergency properties to a composition originally prepared in liquid form.

22. The liquid and viscous cleaning formulation according to claim 18, wherein the formulation has a pH greater than or equal to about 4.0.

23. The liquid and viscous cleaning formulation according to claim 18, wherein the cleaning formulation is capable of cleaning soft or hard surfaces.

24. The liquid and viscous cleaning formulation according to claim 18, wherein the cleaning formulation is capable of cleaning clothes, woven or non-woven, or is capable of cleaning dishes and household utensils, or is capable of cleaning floors or floor coverings.

25. A method for preparing a liquid and viscous cleaning formulation comprising:
substantially completely dissolving in at least one solvent a solid composition comprising
a) from about 6% by weight to about 35% by weight of one or more (di-, tri-, tetra-, penta-, or hexa-) ethoxylated sorbitol esters;
b) from about 2% by weight to about 10% by weight of one or more polyethylene glycol esters;
c) from about 5% by weight to about 35% by weight of one or more non-ionic surfactants;
d) from about 20% by weight to about 70% by weight of one or more anionic surfactant; and
e) from about 0% to about 5% of one or more amphoteric surfactants,
wherein the percentages are calculated based on the total weight of the solid composition,
wherein the at least one solvent is selected from the group consisting of water, a glycol, an alcohol, another polar solvent, combinations thereof, or any other liquid.

26. The method according to claim 25, wherein the solid composition is in the form of powders, flakes, granules, pellets, a pill, a tablet, needles, a lozenge, a disk, a briquette, a bar, a block or mixtures thereof.

27. A method for dispensing a liquid and viscous formulation, comprising:
(i) preparing a viscous and liquid cleaning formulation from a substantially complete dissolution in at least one solvent of a solid composition comprising
a) from about 6% by weight to about 35% by weight of one or more (di-, tri-, tetra-, penta-, or hexa-) ethoxylated sorbitol esters;
b) from about 2% by weight to about 10% by weight of one or more polyethylene glycol esters;
c) from about 5% by weight to about 35% by weight of one or more non-ionic surfactants;
d) from about 20% by weight to about 70% by weight of one or more anionic surfactant;
e) from about 0% to about 5% of one or more amphoteric surfactants,
(ii) contacting the obtained formulation with a surface.

28. The method according to claim 27, wherein said surface is a soft or hard surface.

29. The liquid and viscous cleaning formulation according to claim 20, wherein the cleaning formulation has a viscosity between about 250 mPa·s and about 500 mPa·s at 25° C.

30. The liquid and viscous cleaning formulation according to claim 18, wherein the formulation has a pH between about 7.0 and about 9.0.

31. The liquid and viscous cleaning formulation according to claim 18, wherein the formulation has a pH of about 8.5.

32. The method according to claim 28, wherein said surface is clothing, fabrics or non-wovens, dishes and household utensils, floors or floor coverings.
